(19) United States
(12) Patent Application Publication
(10) Pub. No.: US 2026/0160173 A1
(43) Pub. Date: Jun. 11, 2026

(54) SEALING MEMBER FOR A MOVING BLADE

(71) Applicant: SAFRAN AIRCRAFT ENGINES, PARIS (FR)

(72) Inventors: Yannick DURAND, MOISSY CRAMAYEL (FR); Baptiste Dorian LAWNICZEK, MOISSY CRAMAYEL (FR)

(21) Appl. No.: 19/126,984

(22) PCT Filed: Oct. 31, 2023
(86) PCT No.: PCT/FR2023/051721

§ 371 Date: May 2, 2025

(30) Foreign Application Priority Data
Nov. 4, 2022 (FR) FR2211475

(51) Int. Cl. F01D 11/00; F01D 5/10

(52) U.S. Cl. CPC F01D 11/001; F01D 5/10; F05D 2260/96

(57) ABSTRACT

A turbine engine rotary assembly includes a disc and at least one blade including a stilt wall extending radially from a root situated in a recess of the disc including a first circumferential end surface, a platform which extends at the radially outer end of the stilt and is mounted circumferentially end-to-end with another stilt of another circumferentially adjacent blade, the platform or the stilt including a first coupling element, the assembly also including a sealing member mounted in a cavity including a second coupling element nested with that of the blade for axially retaining the sealing member in the cavity in both directions.

### TECHNICAL FIELD OF THE INVENTION

The technical field of the invention is the sealing at the vane roots of a turbomachine turbine rotor wheel.

This invention relates to a turbomachine rotary assembly comprising vanes and sealing members and in particular a connection between the sealing member and the vane.

### TECHNOLOGICAL BACKGROUND OF THE INVENTION

It is known to use a turbine movable wheel in turbomachines, such as a low-pressure turbine, comprising a disc provided at its periphery with vane-carrying cells.

Especially it is known from document FR3102506, of which FIG. 1 forms part of the state of the art, belonging to the applicant, a turbine wheel comprising a disc 3 and vanes 2 mounted to the disc 3 so as to be evenly distributed about the disc 3. Each vane 2 comprises an attachment root 23 mounted in cells 30 of the disc 3 formed by teeth 31. The cells 30 or grooves are evenly spaced about the periphery of the disc 3 and define the teeth 31 therebetween. Each vane 2 further comprises a stilt 24 which extends radially outwardly from the root 23 of the vane 2. FIG. 2 represents a stilt 24, a root 23 of a vane 2. The stilt 24 comprises a wall 24r extending radially outwardly of the root 23 and a platform 26 which extends at the radially outer end of the stilt 24. Typically, each vane 2 of a turbine wheel comprises a blade 27 connected at its radially inner end to the platform 26.

The stilt 24 further comprises four low walls (three of which are circled in FIG. 2) each located on one of the axial and lateral sides of the central low wall 24r. Thus two of the four low walls are lateral on first axial side and the other two are on the other axial side. On the first axial side, a first lateral upstream low wall 24ac and a second lateral upstream low wall 24bc on the other lateral side (referenced in FIG. 1) extend from an upstream axial end of the axial low wall 24r. On the other axial side, a first downstream low wall 24ad and a second lateral downstream low wall 24bd (referenced in FIG. 2, not represented in FIG. 1) each extend from the downstream axial end of the axial low wall 24r. The low walls extend transversely to the axis of rotation of the turbomachine but are not necessarily radial. The upstream low walls of the vanes are thus circumferentially arranged end-to-end and the same applies to the downstream low walls.

When the movable wheel is assembled, the vane platforms extend circumferentially end-to-end about the disc, by being spaced apart by small clearances J separating their respective platforms.

The platform 26 forms, with the low walls of the stilt 24 of each vane, a first and second half-cavity 24a, 24b which forms a cavity 213 with the half-cavity of an adjacent vane (adjoining vane).

Each low wall also makes it possible to limit air reintroduction into the cavities.

It is further known to mount sealing members in these cavities 213 to limit leakage between the platforms, represented by an inter-platform clearance J in FIG. 1. This leakage corresponds to gas circulating from upstream to downstream of the disc, between the inter-platform clearances, without driving a blade. These members can also be designed to absorb vibrations to which the vanes are subjected during operation. Thus, each sealing member 212, also referred to as a “sweet”, is engaged in a cavity 213 delimited by two half-cavities 24a, 24b of two circumferentially adjacent vanes.

The sealing members are thus axially held on one axial side by the pair of lateral upstream low walls comprising the lateral upstream low wall 24ac with the second lateral upstream low wall 24bc of the adjoining vane and on the other axial side, by the pair of downstream low walls comprising the first downstream low wall 24ad and the second lateral downstream low wall 24ad of the adjoining vane. Stops on these walls to retain the sealing member have also been known. However, there is axial clearance between the sealing member and one of the two pairs of low walls, causing the latter to move axially, which can lead to vibrations and gas leakage problems between one of these two pairs and the uncovered inter-platform clearance J. In particular, this axial clearance exists given the manufacturing restrictions on the sealing member, the vane low walls and mounting restrictions which can lead to an axial offset between two vanes. It is known from documents FR3027950 and EP1507960 of the applicant, sealing members comprising axial end walls comprising lamellae elastically deformed against at least one pair of low walls to avoid this clearance. However, on the one hand, these elastic walls require pairs of low walls, and on the other hand, there are mounting problems to ensure that the sealing member is mounted against the platforms of the two vanes, and problems with life time due to thermal expansion and contraction caused by the thermal stresses on these sealing members.

In operation, the sealing member is centrifugally pressed or elastically held against the inner faces of the platforms of the two adjoining vanes, so as to limit gas leakage through the inter-platform clearance J separating the flanks of these two circumferentially adjacent vanes.

Furthermore, there are Ceramic Matrix Composite (C.M.C.) vanes. The use of this type of material makes it possible to reduce weight of the vanes and increase their resistance to high temperatures, but also requires the geometry of the vanes, in particular the platforms, to be reviewed. Indeed, it is relatively complicated to make a platform including a structure similar to that of prior art, in particular it is complicated to make the stilt low walls, which increases the cost and is furthermore not very robust (low mechanical endurance). Such a structure especially causes problems of twisting of the material fibres during manufacture. Of course, this problem of simplifying structure of platforms can also arise with other types of vanes. There is therefore a need to reduce costs for CMC ceramic matrix composite vanes while avoiding leakage through the inter-platform clearance separating two circumferentially adjacent vanes, which corresponds to a loss of performance, firstly in that it does not generate any driving force, and secondly in that it heats up the disc teeth, making it necessary to increase their cooling with additional fresh gas taken upstream, which leads to a further drop in performance.

It is understood that the shape of each device is dictated by the shape of the vane, more specifically by the geometry of the cavity. To perform mounting of the movable wheel, the operator proceeds as follows. First of all, the operator engages a vane root, from a downstream end for example, into a cell of the disc. The operator then simultaneously mounts a vane/sealing device pair and repeats this operation until the penultimate vane is mounted. Mounting the last vane has to be performed at the same time as the two sealing devices on either side of the vane stilt. This requires technical know-how and training, and it is common for the positioning of this same vane to take as much time as the positioning of all the previously positioned vanes.

There is also a need to reduce mounting time, in particular for the last vane.

From document FR3006364A1, it is known to replace the low walls, on one of the axial sides, with an annular sealing flange mounted in the upstream or downstream part of the disc, the flange extending radially between the platforms and the disc. The flange includes means for rotatably coupling with at least one of the sealing members. The operation thus consists in inserting teeth of this flange, once all the vanes and sealing members have been disposed, into recessed zones in the disc so that they can be inserted axially. Once this insertion has been made, pivoting the flange relative to the disc by a given angular amount enables the teeth of the flange to be positioned facing the teeth of the ring gear, thus preventing accidental removal of the flange.

However, this flange is expensive and furthermore requires the sealing members to be horizontally inserted before the flange is inserted to prevent them from falling off.

There is therefore a need to improve hold of a sealing member between two vanes, in particular of CMC.

### SUMMARY OF THE INVENTION

The invention provides a solution to one of the problems discussed previously, by providing a vane comprising a stilt comprising a coupling element coupled by male-female interlocking with an axial coupling element complementary to a sealing member to hold the sealing member axially in a cavity forming a housing for the sealing member, formed with a neighbouring vane.

The invention is especially intended to provide a simple, effective and economical solution for axially holding the sealing member, by providing a vane, for example of C.M.C., whose structure can be simplified, while ensuring the aforesaid sealing functions.

One aspect of the invention relates to a turbomachine rotary assembly having axis of rotation comprising:
a disc centred on the axis, which has, on its periphery, cells circumferentially delimited by teeth of the disc,
vanes each circumferentially adjacent mounted in a respective cell of the disc, each vane comprising:
   a root mounted in a respective cell of the disc, the root having a shape configured to allow mounting of the root in the respective cell of the disc,
   a stilt formed by a wall which extends radially with respect to the axis outwardly of the root, the wall of the stilt being delimited by a first circumferential end surface, a second circumferential end surface opposite to the first circumferential end surface and two axial end edges opposite to each other,
   a platform which extends at the radially outer end of the stilt and which is located circumferentially end-to-end with another platform of another circumferentially adjacent vane, and a blade which extends radially outwardly of the platform,
at least one sealing member mounted in a cavity delimited, on the one hand, by the disc and, on the other hand, by the stilts and platforms of the vane and the other circumferentially adjacent vane,
wherein:
   the platform or stilt of the vane comprises a first coupling element coupled by male-female interlocking with a second coupling element extending from a wall of the sealing member so as to retain the sealing member with respect to the cavity, axially in both directions while allowing the sealing member to be pressed by centrifugal force against the platforms of the two vanes,
   the sealing member further comprises an upstream surface and a downstream surface and in that the cavity is axially open at least on a downstream or upstream side on the entire downstream surface or upstream surface respectively.

By virtue of the invention, the sealing member is axially held by its second coupling element which is coupled by male-female interlocking with the first coupling element of the platform or stilt. The male-female interlocking avoids axial clearance problems, unlike in prior art wherein the rotary members are pressed against a stop or wall of the vane. Indeed, by virtue of the male-female interlocking of the coupling elements, the sealing member has an axial clearance (or not, as the interlocking can be tightened) that depends solely on the manufacturing tolerances of these coupling elements. As a result, the rotary assembly has a sealing member that is reliably held axially (without thermal stress problems). Furthermore, the sealing member can always be pressed against the platforms of the two vanes by centrifugal force, thereby avoiding mounting errors.

Furthermore, the invention makes it possible to operate with vanes that are free of upstream and/or downstream low walls, simplifying the manufacture of CMC vanes. Furthermore, inserting the last sealing member can be made axially between the two vanes, deforming elastically until the two coupling elements cooperate. This simplifies mounting.

In the application, by “a first coupling element coupled by male-female interlocking with a second coupling element”, it is meant that the first or second coupling element is the female element (hole) and respectively the second or first coupling element is the male element (projection or protrusion) inserted into the female element (hole). Furthermore, by “second coupling element extending from a wall of the sealing member”, it is meant that the second coupling element is a male (projection or protrusion) or female (hole) part of the sealing member connected to a wall together forming a side (a face) of the sealing member.

The coupling elements are therefore complementary, i.e. they have two complementary shapes so that they interlock into each other and mechanically couple the vane to the sealing member in both axial directions.

Finally, the fact that the sealing member further comprises an upstream surface and a downstream surface and that the cavity is axially open at least on a downstream or upstream side on the entire downstream surface or upstream surface respectively, allows the sealing member to be inserted into the cavity. Furthermore, this allows the stilt to be free of a low wall axially closing the cavity.

Further to the characteristics just discussed in the preceding paragraph, the turbine wheel according to one aspect of the invention may have one or more additional characteristics from among the following, considered individually or according to any technically possible combinations:

According to one embodiment, the cavity is open on the upstream and downstream axial sides and the stilt is only the stilt wall.

According to one embodiment, the projection is a plastic deformation of the wall of the sealing member comprising the circumferential end surface.

According to one embodiment, the stilt wall comprises the first circumferential end surface, the second circumferential end surface opposite to the first circumferential end surface and the two axial end edges opposite to each other.

According to one embodiment, the first coupling element is a male coupling element inserted into a groove of the second coupling element, or the second coupling element is a male coupling element inserted into a groove of the first coupling element.

According to one example of this embodiment, the male coupling element has a T-shape, the horizontal part of the T-shape of the male coupling element being located in the female coupling element and the vertical part of the T-shape of the male coupling element extends from one wall of the vane or sealing member to the horizontal part of the T-shape. Thus a T-shape makes it possible to interlock the coupling element of the sealing member extending from one of its walls with the coupling element of one of the walls of the stilt or the platform of the vane while having these two walls spaced apart from each other.

According to one example of this preceding embodiment, the male coupling element is a protrusion projecting from a surface of a wall of the vane or of the sealing member and the female coupling element is a protrusion-receiving housing, the female coupling element extending from a surface of a wall of the sealing member or of the vane respectively.

According to one implementation of this example of this embodiment, the second coupling element comprises a base extending from the surface of the vane wall, and an anchor comprising the complementary shape of the housing forming the first coupling element by filling it.

According to one example of this embodiment, the hole forming the female coupling element is a through hole.

According to one embodiment, the sealing member comprises a circumferential end surface against the first circumferential end surface of the stilt, the second coupling element extending from the circumferential end surface of the sealing member and the first coupling element extending from the first circumferential end surface of the stilt. This provides a circumferential interlock between the sealing member and one of the two vanes forming the cavity housing it. The circumferential interlock enables the vane to be radially connected to the sealing member.

According to one embodiment, the sealing member is hollow. This allows the rotary assembly to be made lighter.

According to one embodiment, the sealing member has first and second circumferential end walls, which respectively have each a complementary shape to the first circumferential end surface and to a second circumferential end surface of a stilt of a neighbouring vane, respectively. This makes it possible to embrace the shape of the cavity and therefore limit leakage.

According to one embodiment, the first and second circumferential end walls are curved.

According to one embodiment:
the sealing member comprises a radially outer end surface,
the platform comprises a first and a second circumferential end edge (also referred to as a wall) each having respectively a first radially inner surface and a second radially inner surface each respectively delimiting the cavity forming the housing for the sealing member and a cavity forming a housing for a second sealing member, the first radially inner surface and the second inner surface each facing respectively the radially outer end surface of the sealing member and a radially outer end surface of the second sealing member,
an inter-platform clearance is formed between the first circumferential end edge and the second circumferential end edge of a circumferentially adjacent vane, the radially outer end surface of the sealing member radially extends below the inter-platform clearance.

According to one embodiment,
the platform comprises first and second circumferential end walls (or edges) each extending respectively towards first and second other circumferential end walls of first and second other vanes circumferentially adjacent to that vane, each of those circumferential end walls comprising a first radially inner surface delimiting the cavity housing the sealing element,
the first coupling element extends from the first radially inner surface of the first circumferential end wall of the platform,
the sealing member comprises a radially outer end surface partially facing the first radially inner surface of the first circumferential end wall of the platform,
the second coupling element extending from the radially outer end surface of the member.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 shows a schematic representation of a radial cross-section of a portion of a turbomachine rotary assembly according to prior art, comprising vanes mounted to a disc and a sealing member between two vanes.

FIG. 2 represents a three-dimensional view of a vane according to prior art.

FIG. 3 represents a three-dimensional view of a vane of a turbomachine rotary assembly according to one example of a first embodiment.

FIG. 4 represents a three-dimensional view of a sealing member of the turbomachine rotary assembly according to the example of the first embodiment.

FIG. 5 represents a cross-sectional view of part of the turbomachine rotary assembly according to the example of the first embodiment.

FIG. 6 represents a three-dimensional view of an assembly of the turbomachine rotary assembly according to the example of the first embodiment, comprising the vane of FIG. 3 and the sealing member of FIG. 4.

FIG. 7 represents a three-dimensional view of a disc and a vane of the turbomachine rotary assembly according to a second example of the first embodiment.

FIG. 8 represents a three-dimensional view of part of the turbomachine rotary assembly according to this second example of the first embodiment.

FIG. 9 represents a cross-section of the part of the turbomachine rotary assembly according to this first example of the first embodiment.

FIG. 10 represents a three-dimensional view of a vane of the turbomachine rotary assembly according to one example of a third embodiment.

FIG. 11 represents a cross-section of the part of the turbomachine rotary assembly according to the example of the third embodiment.

### DETAILED DESCRIPTION

The figures are set forth by way of indicating and in no way limiting purposes of the invention.

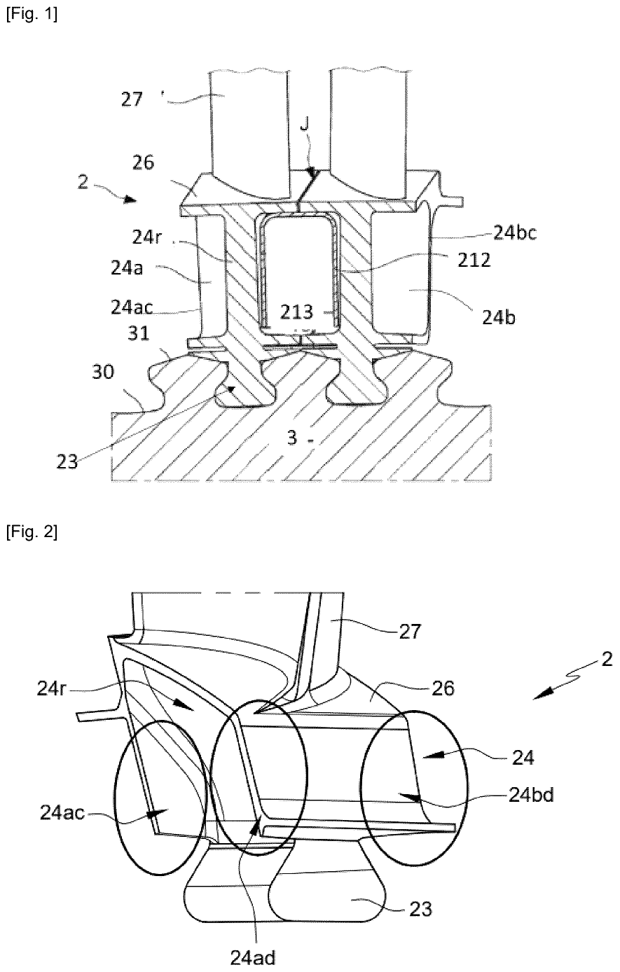

The invention relates to a turbomachine rotary assembly having axis X of rotation, which may be a turbine movable wheel. The turbomachine rotary assembly having axis X of rotation comprises a disc 3 centred on the axis X, vanes 1 and sealing members 5. The disc 3 is like the one in FIG. 1 described in prior art section. At its periphery, the disc 3 has cells 30 and circumferentially alternating teeth 31, such that two neighbouring teeth 31 delimit a cell 30.

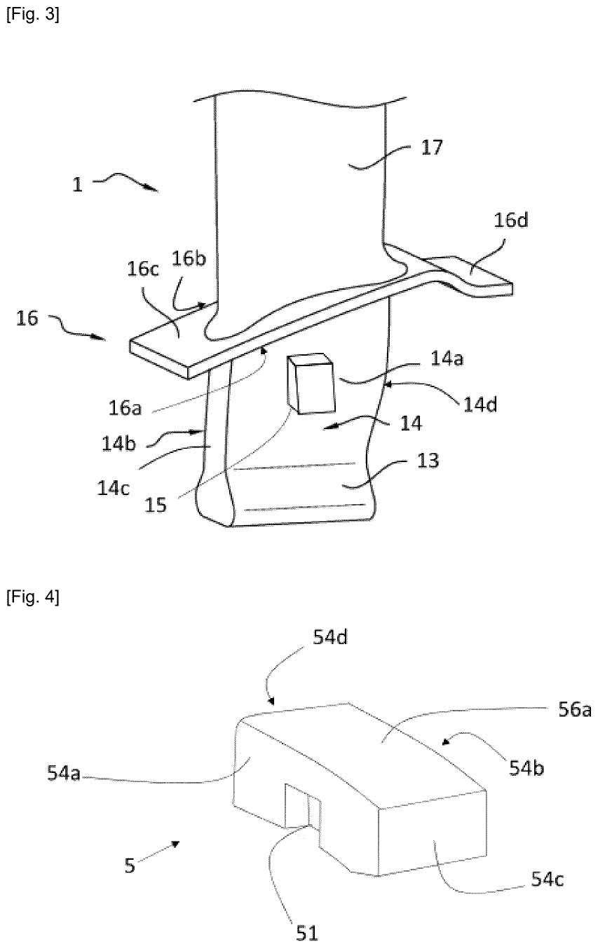

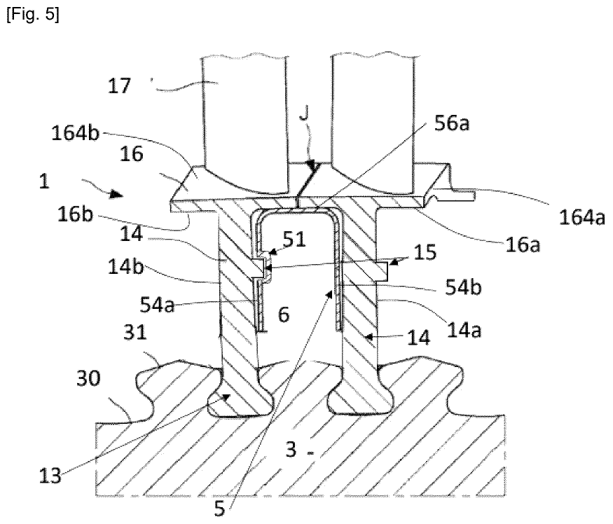

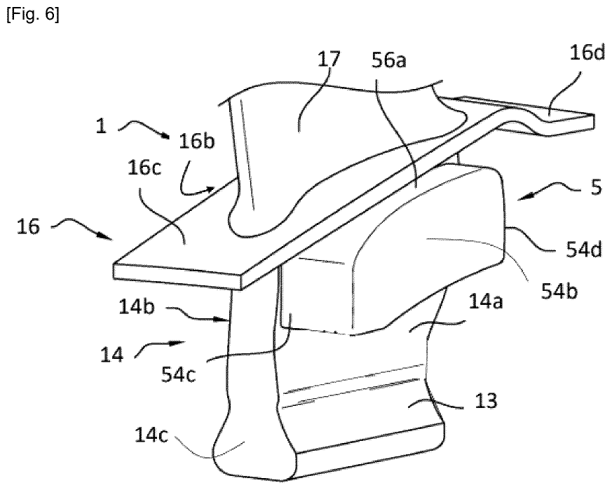

FIG. 3 represents a three-dimensional view of part of one of the vanes 1 of a turbomachine rotary assembly according to a first example of the first embodiment, FIG. 4 represents a three-dimensional view of one of the sealing members 5 of the turbomachine rotary assembly, FIGS. 5 and 6 respectively represent a radial cross-section and a three-dimensional view of part of the turbomachine rotary assembly.

Each vane 1 comprises a root 13 mounted in a cell 30 of the disc 3. The root 13 is shaped to allow mounting of the root 13 in a respective cell 30 of the disc, between two teeth 31 of the disc 3 to retain the vane 3 radially against centrifugal force and gravity.

The vane 1 comprises a stilt 14 which is herein formed by a wall which extends from the root 13 radially outwardly from the axis X. The stilt 14 comprises a first circumferential end surface 14a, a second circumferential end surface 14b opposite to the first circumferential end surface 14a and a first and a second axial end edge 14c, 14d, also referred to as the upstream axial end edge 14c and the downstream axial end edge 14d (upstream and downstream being the direction of air flow between the blades). In this embodiment, each axial end edge 14c, 14d is free. Each axial end edge 14c, 14d joins the first to the second circumferential end surface 14a, 14b.

The first circumferential end surface 14a and the second circumferential end surface 14b may be radially and/or axially curved, herein the first circumferential end surface 14a is axially concave and the second circumferential end surface 14b is axially convex (but this may be reversed, concave for the second circumferential end surface 14b, and convex for the first circumferential end surface 14a). The first circumferential end surface 14a and the second circumferential end surface 14b may be planar too.

In this embodiment, the vane 1 comprises a first coupling element 15 extending from the circumferential end surface 14a. Herein, in this embodiment, the first coupling element 15 is a male coupling element, herein a projecting protrusion extending from the circumferential end surface 14a. The first coupling element 15 is herein spaced from the first and second axial end edges 14c, 14d. The function of this first coupling element 15 is explained below.

The vane 1 further comprises a platform 16 extending from the stilt 14 opposite to the root 13.

Platform 16 extends at the radially outer end of stilt 14 and is mounted circumferentially end-to-end with another platform of another circumferentially adjacent vane transversely to stilt 14, forming transversely extending walls of each circumferential end surface 14a, 14b and each axial end edge 14c, 14d. The circumferentially adjacent vane is hereinafter referred to as the neighbouring vane. Herein the platform 16 is tilted relative to the stilt 14, such that the platform 16 is closer to the root 13 from the upstream side than from the downstream side. According to another example, platform 16 is tilted relative to stilt 14 in the other direction, i.e. platform 16 is closer to root 13 on the downstream side than from the upstream side. According to another example, the platform 16 extends axially perpendicularly with respect to the stilt 14, i.e. the platform 16 is at an equal distance from the root 13 on the downstream side and upstream side. The platform is perpendicular relative to each circumferential end surface 14a, 14b.

The platform 16 thus comprises, in this example, an upstream low wall 16c extending radially tilted from the first axial end edge 14c of the stilt 14 forming a spoiler extending axially upstream.

The platform 16 thus comprises, in this example, a downstream wall 16d radially tilted from the second axial end edge 14d of the stilt 14 forming a spoiler extending axially downstream.

The platform 16 thus comprises a first circumferential end wall 164a and a second circumferential end wall 164b each extending respectively from the first circumferential end surface 14a, and the circumferential end surface 14b. The first circumferential end wall 164a thus comprises a first radially inner surface 16a extending transversely from the first circumferential end surface 14a of the stilt 14 and the second circumferential end wall 164b comprises a second radially inner surface 16a extending from the second circumferential end surface 14b. These two walls 164a, 164b are in this example axially tilted (i.e. the downstream end is further from the root 13 than the upstream end of these walls) relative to the stilt 14 but the tilt can be reversed or even without tilt (the platform 16 extends axially perpendicularly relative to the stilt 14) as previously mentioned. The first and second circumferential end walls 164a, 164b are also each referred to as the first and second circumferential end edge respectively.

Hereafter, to simplify the description, the term “radially” may be omitted from the characteristics of the first or second radially inner surfaces 16a, 16b, which may therefore be referred to as the first or second inner surface 16a, 16b.

The first inner surface 16a thus extends from the first circumferential end surface of the stilt 14 towards a second inner surface 16b of another platform 16 of a neighbouring vane 1 mounted in an adjacent cell of the disc 3. A cavity 6 forming a housing for a sealing member 5 is formed between the two neighbouring vanes and the disc 3, more precisely radially delimited between a tooth 31 of the disc 3 and two inner surfaces 16a, 16b of two platforms 16 of two neighbouring vanes and circumferentially delimited between the first circumferential end surface 14a of the stilt 14 of the vane 1 and the second circumferential end surface 14b of the stilt 14 of the other neighbouring vane 1. The cavity 6 forming the housing for the sealing member 5 is axially open at least at one axial end, herein at both axial ends. The cavity 6 is axially open on both sides in these examples of these embodiments. The vanes 1′ are herein made of CMC composite but could also be made of metal.

The first inner surface 16a therefore defines, with the second inner surface 16b of the circumferentially adjacent vane, an upper wall of the housing 6 of the sealing member 5.

In other words, the first inner surface 16a and the first circumferential end surface 14a together form a first volume of a half-housing of the housing for the sealing member 5 and the second inner surface 16b and the second circumferential end surface 14b together form a half-volume of another housing 6 of another sealing member 5 formed with another adjacent vane.

The sealing member 5 (represented alone in FIG. 4), also referred to as a sweet, comprises a radially outer end surface 56a, part of which faces the first inner surface 16a of the platform 16 of the vane 1 and another part of which faces the second inner surface 16b of the platform of the neighbouring vane (represented in FIG. 5).

Another sealing member 5 (not represented) also comprises a radially end surface 56a, part of which is mounted facing the second inner surface 16b of the platform 16 of vane 1 and another part of this radially outer end surface 56a is facing the first radially inner outer surface 16a of the platform of the other neighbouring vane (not represented).

Hereinafter, to simplify the description, the term “radially” may be omitted from the characteristic radially outer end surface 56a, which may therefore be referred to as outer end surface 56a.

Herein in this example, the outer end surface 56a of each sealing member 5 is in contact with the first and second inner surfaces 16a, 16b of two circumferentially neighbouring platforms 16 of two circumferentially neighbouring vanes.

The sealing member 5 further comprises an upstream surface 54c and a downstream surface 54d.

The sealing member 5 further comprises a first and a second circumferential end surface 54a, 54b (one is visible in FIGS. 4 and 5 and the other in FIGS. 5 and 6) mounted facing the first circumferential end surface 14a and the second circumferential end surface 14b respectively of the neighbouring vane.

The upstream surface 54c and the downstream surface 54d each connect the first and second circumferential end surfaces 54a, 54b.

The sealing member 5 is hollow herein but could be solid. Herein, the sealing member 5 therefore comprises two circumferential end walls, an upstream wall, a downstream wall and a radially outer wall.

The sealing member 5 further comprises a second coupling element 51 interlocked with the first coupling element 15 of the vane, for axially retaining the sealing member 5 in both directions in the cavity 6. Herein, the second coupling element 51 is a female coupling element, herein a hole extending from the circumferential end surface 54a, which may be a through hole or as in this example is a deformation of the circumferential end wall. In this example, the first coupling element 15 is therefore interlocked into the second coupling element 51.

In this way, the sealing member 5 is retained in the cavity 6 by these two coupling elements 15 and 51 in both axial directions. The sealing member 5 therefore has its downstream surface 54d and its upstream surface 54c free, i.e. in the machine flow direction. This embodiment makes it possible to have a vane 1 free of low walls axially closing the cavity 6. According to this embodiment, the vane can be made more easily from Ceramic Matrix Composite (CMC). The sealing member can be metallic.

The vane 1 further comprises a blade 17 extending radially from the platform 16 opposite to the stilt 14.

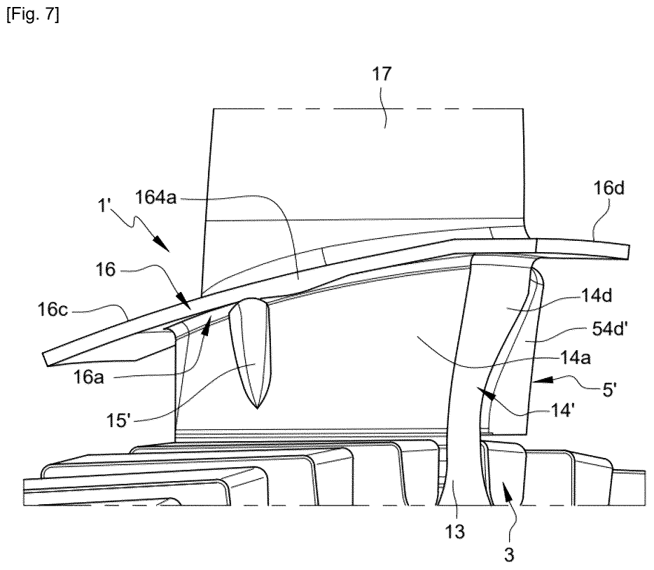

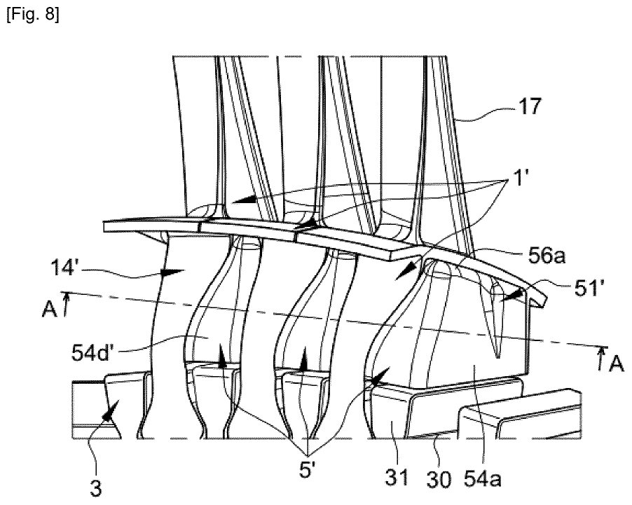

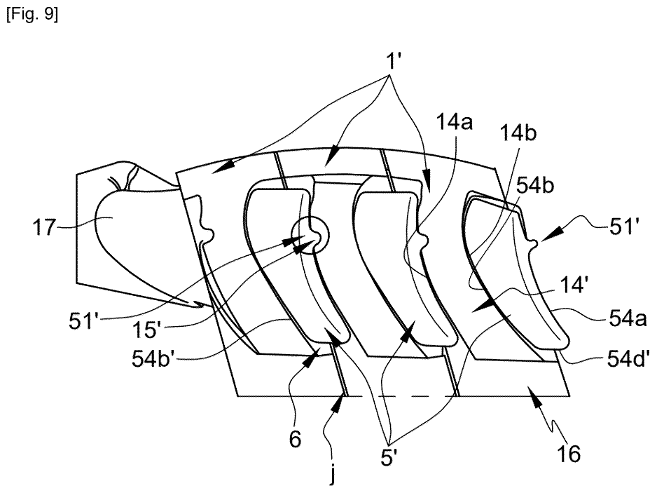

FIGS. 7 and 8 each represent a different three-dimensional view of a portion of disc 3, at least one vane 1′, and at least one sealing element 5′, of a turbomachine rotary assembly according to one example of the second embodiment. In particular, FIG. 7 represents a single vane 1′ and a single sealing member 5′, while FIG. 8 represents the disc 3 with three vanes 1′ and three sealing members 5′. FIG. 9 schematically represents a section A-A of FIG. 8.

The elements designated by a reference comprising an apostrophe “′” are different from the first example in this embodiment. The elements having the same reference are therefore substantially identical.

FIGS. 7 and 8 show a three-dimensional view from the downstream side. The downstream surface 54d′ and the axial end edges 14d of the stilt 14′ of each vane 1 can thus be seen therein.

Furthermore, the root 13 of each vane 1′ can be seen housed in a cell 30 formed between two teeth 31.

The vane 1′ of this second example of this embodiment is different from the vane 1 of the first example of this embodiment in that the coupling element 15′ is female, herein forming a housing for receiving the other coupling element, herein it is a non-through hole. The stilt 14′ is therefore different from that of the first embodiment in that the female coupling element 15′ is a hole which extends from the first circumferential end surface 14a inwardly of the stilt 14′, i.e. towards its second circumferential end surface 14b.

The sealing member 5′ of this second example of this embodiment is therefore different from the sealing member 5 of the first example of this embodiment in that the second coupling element 51′ is a protrusion projecting from the first circumferential end surface 54a forming a protrusion towards the vane 1′. The second coupling element 51′ of each sealing member 5′ is therefore housed in the female coupling element 15′ extending from the first circumferential end surface 14a of the stilt 14 of each corresponding vane 1′, as is visible in the circle represented in cross-section A-A of FIG. 9. Further, the inter-platform clearance j between the two platforms 16 can be seen in this FIG. 9.

Furthermore, the overall shape of this sealing member 5′ is blade-shaped and is different from that of the first example, which is closer to a parallelepiped shape. However, the first and second circumferential end surfaces 54a and 54b are, as in the first example, in contact with the first and second circumferential end surfaces 14a, 14b of two adjacent vanes 1′ respectively. Indeed, in these different examples of these embodiments, the faces 54a and 54b of the sealing member 5, 5′ are a footprint of the faces 14a and 14b of the stilts 14 of the vanes 1.

In FIG. 8, it can be seen in this second example, as in the first example, that the radially outer end surface 56a of each sealing member 5′ is in contact with the inner surface of each platform 16.

Furthermore, as in the first example, in this second example the upstream and downstream surfaces of each sealing member 5′ are free.

According to another embodiment not represented, the sealing member comprises more than a single coupling element, for example a third coupling element extending from the second circumferential end surface interlocked with a fourth coupling element extending from the second circumferential end face of the stilt.

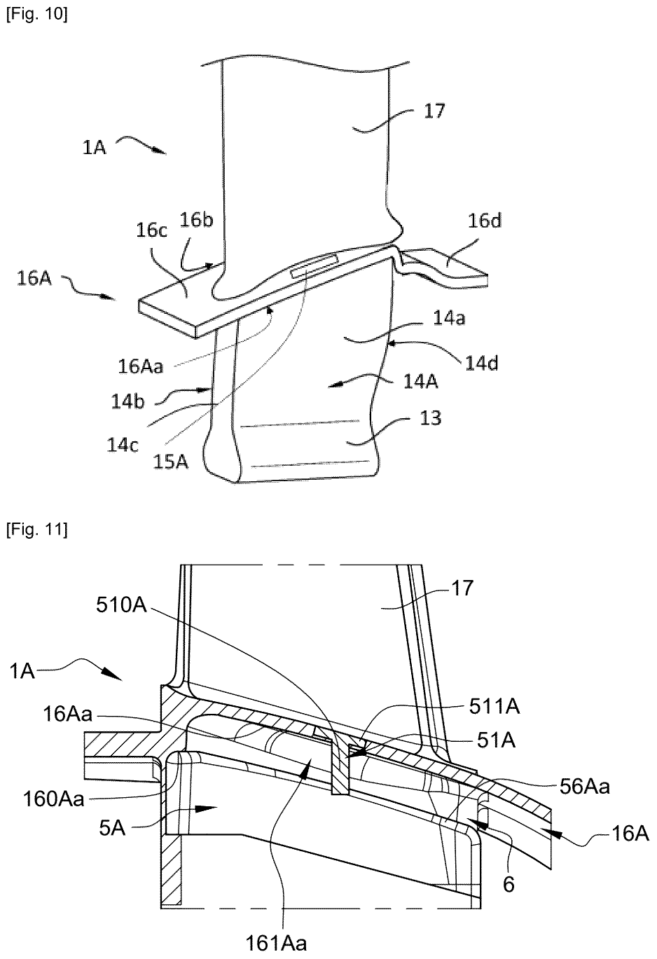

FIG. 10 represents a vane 1A of the turbomachine rotary assembly of a second embodiment, and FIG. 11 represents a radial cross-section of the vane 1A and a sealing member 5A of the turbomachine rotary assembly of the second embodiment.

The elements designated by a reference comprising a capital “A” are different from the first embodiment.

The vane 1A is identical to that of the first example of the first embodiment except that the platform 16A comprises the first coupling element 15A (belonging in place of the stilt in the first embodiment). The first coupling element 15A extends from the first inner surface 16Aa of the first circumferential end wall 164Aa. Herein, in this example of this second embodiment, the first coupling element 15A is a female coupling element, like the second example of the first embodiment. The first coupling element 15A is a hole extending from the inner surface 16Aa into the first circumferential end wall 164Aa of the platform 16. The first coupling element 15A could also, according to another example, as in the first example of the first embodiment, be male, i.e. a protrusion projecting from the inner surface 16Aa.

The stilt 14A is therefore free of coupling elements in this example of this embodiment. In this example, the first coupling element 15A is an opening, i.e. a hole passing through the first circumferential end wall 164Aa of the platform 16A.

The sealing member 5A is therefore also different from the first embodiment in that the second coupling element 51A extends from the radially outer end surface 56Aa. The second coupling element 51A is therefore a male coupling element interlocked within the first coupling element 15A.

Furthermore, in this example of this embodiment, the platform 16A comprises an inner border 160Aa radially distant from the inner surface 16Aa of the platform 16A, surrounding a recess 161Aa. The inner border 160Aa thus forms a step. A perimeter of the radially outer end surface 56Aa of the seal 5A is in contact with the inner border 160Aa. Thus the recess 161Aa is formed between the portion surrounded by the perimeter of the radially outer end surface 56Aa and the inner surface 16Aa. The recess is thus sealed by the perimeter of the sealing member in contact with this inner border 160Aa. This characteristic of this example can also be applied to the first embodiment.

Of course, according to another example, as in the first embodiment, the radially outer end surface 56Aa may also be in contact with the inner surface 16Aa of the platform 16A.

In this example, the second coupling element 51A of the sealing member 5A therefore comprises a base 510A extending from the radially outer end surface 56A towards the first inner surface 16Aa of the platform 16 in the recess 161Aa. The second coupling element 51A further comprises an anchor 511A extending at the end of the base 510A opposite to the radially outer end surface 56A housed in the receiving housing formed by the first coupling element 15A. The anchor 511A comprises a shape corresponding to that of the receiving housing formed by the first coupling element 15A to hermetically fill it. In this example the base and anchor have a different cross-section but could have the same cross-section. In this example, the male coupling element 51A has a T-shape, the horizontal part of the T-shape of the male coupling element being the anchor 511A located in the female coupling element 15A and the vertical part of the T-shape of the male coupling element 51A is the base 510A extending from a wall of the vane or sealing member to the horizontal part of the T-shape.

According to another embodiment not represented, the vane comprises the first coupling element according to one of the embodiments and a third coupling element according to one of the embodiments on the second circumferential end surface of the stilt or on the second inner surface of the platform.

In the different embodiments, the sealing member therefore makes it possible to seal the inter-platform clearance J while being held axially in both directions between two circumferential end walls of the vane root by its second coupling element complementary to the first coupling element of the vane located between the two axial end edges and remote therefrom.

According to another embodiment not represented, the vane is identical to one of the described embodiments except that the stilt comprises, further to the stilt, a single axial low wall further extending from one of the circumferential end surfaces 14a, 14b axially closing in one direction the cavity 6 with another low wall of the stilt of the neighbouring vane. This makes it possible to limit leakage.

All of the vanes and sealing members of the turbomachine rotary assembly may comprise the characteristics of one of the examples of the different embodiments previously described. Each vane and sealing member may be different from another vane and sealing member respectively, or may all be identical.

Unless otherwise specified, a same element appearing in different figures has a single reference.

1. A turbomachine rotary assembly having axis of rotation comprising:
a disc centred on the axis which has, on its periphery, cells circumferentially delimited by teeth of the disc,
vanes each circumferentially adjacent mounted in a respective cell of the disc each vane comprising:
a root mounted in a respective cell of the disc the root having a shape configured to allow mounting of the root in the respective cell of the disc,
a stilt formed by a wall which extends radially with respect to the axis outwardly of the root the wall of the stilt being delimited by a first circumferential end surface, a second circumferential end surface opposite to the first circumferential end surface and two axial end edges opposite to each other,
a platform which extends at the radially outer end of the stilt and which is located circumferentially end-to-end with another platform of another circumferentially adjacent vane, and
a blade extending radially outwardly of the platform,
at least one sealing member mounted in a cavity delimited, on the one hand, by the disc and, on the other hand, by the stilts and the platforms of the vane and of the other circumferentially adjacent vane,
wherein:
the platform or the stilt of the vane comprises a first coupling element coupled by male-female interlocking with a second coupling element extending from a wall of the sealing member so as to retain the sealing member with respect to the cavity axially in both directions while allowing the sealing member to be pressed by centrifugal force against the platforms of the two vanes,
the sealing member further comprises an upstream surface and a downstream surface and wherein the cavity is axially open at least on a downstream or upstream side on the entire downstream surface or upstream surface respectively.

2. The rotary assembly according to claim 1, wherein the first coupling element is a male coupling element inserted into a groove of the second coupling element, or the second coupling element is a male coupling element inserted into a groove of the first coupling element.

3. The rotary assembly according to claim 2, wherein the male coupling element has a T-shaped, the horizontal part of the T-shape of the male coupling element being located in the female coupling element and the vertical part of the T-shape of the male coupling element extending from a wall of the vane or sealing member to the horizontal portion of the T-shape.

4. The rotary assembly according to claim 2, wherein the male coupling element is a protrusion projecting from a surface of a wall of the vane or of the sealing member and the female coupling element is a protrusion-receiving housing, the female coupling element extending from a surface of a wall of the sealing member or of the vane respectively.

5. The rotary assembly according to claim 4, wherein the second coupling element comprises a base extending from the surface of the wall of the vane, and an anchor comprising the complementary shape of the housing forming the first coupling element by filling it.

6. The rotary assembly according to claim 4, wherein the receiving housing forming the female coupling element is a hole passing through the wall.

7. The rotary assembly according to claim 1, wherein the sealing member comprises a circumferential end surface against the first circumferential end surface of the stilt, the second coupling element extending from the circumferential end surface of the sealing member and the first coupling element extending from the first circumferential end surface of the stilt.

8. The rotary assembly according to claim 1, wherein the sealing member is hollow.

9. The rotary assembly according to claim 1, wherein the sealing member has first and second circumferential end walls which respectively have each a complementary shape to the first circumferential end surface of the stilt and to a second circumferential end surface of a stilt of a circumferentially adjacent vane.

10. The rotary assembly according to claim 9, wherein the first and a second circumferential end wall are curved.

11. The rotary assembly according to claim 1, wherein
the sealing member comprises a radially outer end surface,
the platform comprises a first and a second circumferential end edge each having respectively a first radially inner surface and a second radially inner surface each respectively delimiting the cavity forming the housing for the sealing member and a cavity forming a housing for a second sealing member the first radially inner surface and the second radially inner surface each respectively facing the radially outer end surface of the sealing member and a radially outer end surface of the second sealing member,
an inter-platform clearance is formed between the first circumferential end edge and the second circumferential end edge of a circumferentially adjacent vane, the radially outer end surface of the sealing member extending radially below the inter-platform clearance.
